(19) United States
(12) Patent Application Publication
(10) Pub. No.: US 2021/0064953 A1
(43) Pub. Date: Mar. 4, 2021

(54) SUPPORT SYSTEM FOR DESIGNING AN ARTIFICIAL INTELLIGENCE APPLICATION, EXECUTABLE ON DISTRIBUTED COMPUTING PLATFORMS

(71) Applicant: BULL SAS, Les Clayes-sous-Bois (FR)

(72) Inventors: François M. EXERTIER, SAINT MARTIN D'URIAGE (FR); Mathis GAVILLON, LE VERSOUD (FR)

(21) Appl. No.: 17/004,220

(22) Filed: Aug. 27, 2020

(30) Foreign Application Priority Data
Aug. 30, 2019 (EP) 19194722.5

(51) Int. Cl. G06N 3/00; G06N 3/08

(52) U.S. Cl. CPC G06N 3/008; G06N 3/08

(57) ABSTRACT

A system using a suite of modular and clearly structured Artificial Intelligence application design tools (SOACAIA), executable on distributed or undistributed computing platforms to browse, develop, make available and manage AI applications, this set of tools implementing three functions. A Studio function making it possible to establish a secure and private shared space for the company. A Forge function making it possible to industrialize AI instances and make analytical models and their associated datasets available to the development teams. An Orchestration function for managing the total implementation of the AI instances designed by the Studio function and industrialized by the Forge function and to perform permanent management on a hybrid cloud or HPC infrastructure.

### TECHNICAL FIELD AND SUBJECT MATTER OF THE INVENTION

The present invention relates to the field of artificial intelligence (AI) applications on computing platforms.

### PRIOR ART

According to the prior art, certain users of an artificial intelligence application perform tasks (FIG. 1) of development, fine-tuning and deployment of models.

This has disadvantages; in particular, they do not enable these users to focus on their main activity.

The invention therefore aims to solve these disadvantages by proposing to users (the Data Scientist, for example) a device which automates part of the conventional process for developing machine learning (ML) models, and also the method for using same.

### GENERAL PRESENTATION OF THE INVENTION

The aim of the present invention is therefore that of overcoming at least one of the disadvantages of the prior art by proposing a device and a method which simplify the creation and the use of artificial intelligence applications.

In order to achieve this result, the present invention relates to a system using a suite of modular and clearly structured Artificial Intelligence application design tools (SOACAIA), executable on distributed computing platforms to browse, develop, make available and manage AI applications, this set of tools implementing three functions:
A Studio function making it possible to establish a secure and private shared space for the company wherein the extended team of business analysts, data scientists, application architects and IT managers can communicate and work together collaboratively;
A Forge function making it possible to industrialize AI instances and make analytical models and their associated datasets available to the development teams, subject to compliance with security and processing conformity conditions;
An Orchestration function for managing the total implementation of the AI instances designed by the STUDIO function and industrialized by the Forge function and to perform permanent management on a hybrid cloud infrastructure.

Advantageously, the AI applications are made independent of the support infrastructures by the TOSCA*-supported orchestration which makes it possible to build applications that are natively transportable through the infrastructures.

According to a variant of the invention, the STUDIO function comprises an open shop for developing cognitive applications comprising a prescriptive and machine learning open shop and a deep learning user interface.

In a variant of the invention, the STUDIO function provides two functions:

a first, portal function, providing access to the catalog of components, enabling the assembly of components into applications (in the TOSCA standard) and making it possible to manage the deployment thereof on various infrastructures;
a second, MMI and FastML engine user interface function, providing a graphical interface providing access to the functions for developing ML/DL models of the FastML engine.

According to another variant, the portal of the studio function (in the TOSCA standard) provides a toolbox for managing, designing, executing and generating applications and test data and comprises:

an interface allowing the user to define each application in the TOSCA standard based on the components of the catalog which are brought together by a drag-and-drop action in a container (DockerContainer) and, for their identification, the user associates, via this interface, values and actions, in particular volumes corresponding to the input and output data (DockerVolume);
a management menu makes it possible to manage the deployment of at least one application (in the TOSCA standard) on various infrastructures by offering the different infrastructures (Cloud, Hybrid Cloud, cloud hybrid, HPC, etc.) proposed by the system in the form of a graphical object and by bringing together the infrastructure on which the application will be executed by a drag-and-drop action in a “compute” object defining the type of computer.

According to another variant, the Forge function comprises pre-trained models stored in memory in the system and accessible to the user by a selection interface, in order to enable transfer learning, use cases for rapid end-to-end development, technological components as well as to set up specific user environments and use cases.

In one variant of the invention, the Forge function comprises a program module which, when executed on a server, makes it possible to create a private workspace shared across a company or a group of accredited users in order to store, share, find and update, in a secure manner (for example after authentication of the users and verification of the access rights (credentials)), component plans, deep learning frameworks, datasets and trained models and forming a warehouse for the analytical components, the models and the datasets.

According to another variant, the Forge function comprises a program module and an MMI interface making it possible to manage a catalog of datasets, and also a catalog of models and a catalog of frameworks (Fmks) available for the service, thereby providing an additional facility to the Data Scientist.

According to another variant, the Forge function proposes a catalog providing access to components:

Of Machine Learning type, such as ML frameworks (e.g. Tensorflow*), but also models and datasets
of Big Data Analytics type (e.g. the Elastic* suite, Hadoop* distributions, etc.) for the datasets.

According to another variant, the Forge function is a catalog providing access to components constituting development Tools (Jupyter*, R*, Python*, etc.).

According to another variant, the Forge function is a catalog providing access to template blueprints.

In another variant of the invention, the operating principle of the orchestration function performed by a program module of an orchestrator, preferably Yorc (predominantly open-source, known to a person skilled in the art), receiving a TOSCA* application as described above (also referred to as topology) is that of allocating physical resources corresponding to the Compute component (depending on the configurations, this may be a virtual machine, a physical node, etc.), then it will install, on this resource, software specified in the TOSCA application for this Compute, in this case a Docker container, and in our case mount the specified volumes for this Compute.

According to another variant, the deployment of such an application (in the TOSCA standard) by the Yorc orchestrator is carried out using the Slurm plugin of the orchestrator which will trigger the planning of a slurm task (scheduling of a slurm job) on a high performance computing (HPC) cluster.

According to another variant, the Yorc orchestrator monitors the available resources of the supercomputer or of the cloud and, when the required resources are available, a node of the supercomputer or of the cloud will be allocated (corresponding to the TOSCA Compute), the container (DockerContainer) will be installed in this supercomputer or on this node and the volumes corresponding to the input and output data (DockerVolume) will be mounted, then the container will be executed.

In another variant, the Orchestration function (orchestrator) proposes to the user connectors to manage the applications on different infrastructures, either in Infrastructure as a Service (IaaS) (such as, for example, AWS*, GCP*, Openstack*, etc.) or in Content as a Service (CaaS) (such as, for example, Kubernetes for now*), or in High-Performance Computing HPC (such as, for example, Slurm*, PBS* planned).

According to another variant of the invention, the system further comprises a fast machine learning engine FMLE (FastML Engine) in order to facilitate the use of computing power and the possibilities of high-performance computing clusters as execution support for machine learning training models and specifically deep learning training models.

The invention further relates to the use of the system according to one of the particular features described above for forming use cases, which will make it possible in particular to enhance the collection of “blueprints” and Forge components (catalog): The first use cases identified being:

cybersecurity, with use of the AI for Prescriptive SOCs;

### Cognitive Data Center (CDC)

computer vision, with video surveillance applications.

Other particular features and advantages of the present invention are detailed in the following description.

### PRESENTATION OF THE FIGURES

Other particular features and advantages of the present invention will become clear from reading the following description, made in reference to the appended drawings, wherein:

FIG. 1 is a schematic depiction of the overall architecture of the system using a suite of modular tools according to one embodiment;

FIG. 2 is a detailed schematic depiction showing the work of a user (for example the Data scientist) developing, fine-tuning and deploying a model, and the different interactions between the modules.

### DESCRIPTION OF PREFERRED EMBODIMENTS OF THE INVENTION

The figures disclose the invention in a detailed manner in order to enable implementation thereof. Numerous combinations can be contemplated without departing from the scope of the invention. The described embodiments relate more particularly to an exemplary embodiment of the invention in the context of a system (using a suite of modular and clearly structured Artificial Intelligence tools executable on distributed computing platforms) and a use of said system for simplifying, improving and optimizing the creation and the use of artificial intelligence applications. However, any implementation in a different context, in particular for any type of artificial intelligence application, is also concerned by the present invention. The suite of modular and clearly structured tools executable on distributed computing platforms comprises:

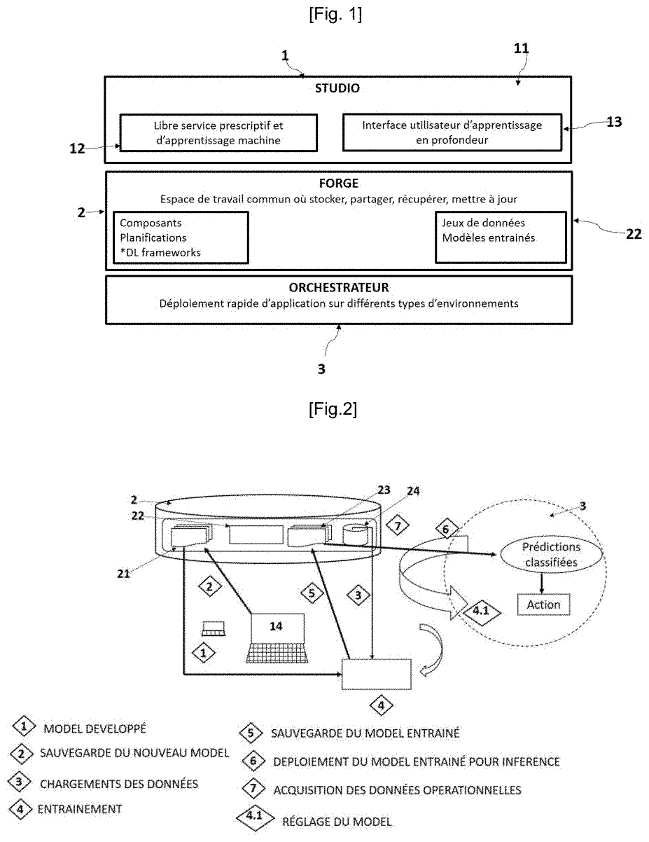

FIG. 1 shows a system using a suite of modular and clearly structured Artificial Intelligence application design tools (SOACAIA), executable on distributed computing platforms (cloud, cluster) or undistributed computing platforms (HPC) to browse, develop, make available and manage AI applications, this set of tools implementing three functions distributed in three functional spaces.

A Studio function (1) which makes it possible to establish a secure and private shared workspace (22) for the company wherein the extended team of business analysts, data scientists, application architects and IT managers who are accredited on the system can communicate and work together collaboratively.

In a variant, the Studio function (1) makes it possible to merge the demands and requirements of various teams regarding for example a project, thereby improving the efficiency of these teams, and accelerates the development of said project.

In a variant, the users have available to them libraries of components which they can enhance, in order to exchange them with other users of the workspace and make use thereof for accelerating tests of prototypes, validating the models and the concept more quickly.

In addition, in another variant, the Studio function (1) makes it possible to explore, quickly develop and easily deploy on several distributed or undistributed computing platforms. Another functionality of Studio is that of accelerating the training of the models by automating execution of the jobs. The work quality is improved and made easier.

According to one variant, the STUDIO function (1) comprises an open shop for developing cognitive applications (11). Said open shop for developing cognitive applications comprises a prescriptive machine learning open shop (12) and a deep learning user interface (13).

A variant of the STUDIO function (1) provides a first portal function which provides access to the catalog of components, to enable the assembly of components into applications (in the TOSCA standard) and manages the deployment thereof on various infrastructures.

The TOSCA standard (Topology Orchestration Specification for Cloud Applications) is a standard language for describing a topology (or structure) of cloud services (for example, non-limiting, Web services), the components thereof, the relationships thereof and the processes that manage them. The TOSCA standard comprises specifications describing the processes for creating or modifying services (for example Web services).

Next, in another variant, a second, MMI (Man-Machine Interface) function of the FastML engine provides a graphical interface providing access to the functions for developing ML (Machine Learning)/DL (Deep Learning) learning models of the FastML engine.

Another variant of the STUDIO function (1) (in the TOSCA standard) provides a toolbox for managing, designing, executing and generating applications and test data and comprises:
an interface allowing the user to define each application in the TOSCA standard based on the components of the catalog which are brought together by a drag-and-drop action in a container (DockerContainer) and, for their identification, the user associates to them, via this interface, values and actions, in particular volumes corresponding to the input and output data (DockerVolume);
a management menu makes it possible to manage the deployment of at least one application (in the TOSCA standard) on various infrastructures by offering the different infrastructures (Cloud, Hybrid Cloud, cloud hybrid, HPC, etc.) proposed by the system in the form of a graphical object and by bringing together the infrastructure on which the application will be executed by a drag-and-drop action in a “compute” object defining the type of computer.

A variant of the STUDIO function (1) is that of dedicating a deep learning engine that iteratively executes the training and intensive computing required and thus of preparing the application for its real use.

Built on the principles of reusing best practices, the Forge function (2) is a highly collaborative workspace, enabling teams of specialist users to work together optimally.

In one variant, the Forge function (2) provides structured access to a growing repository of analytical components, and makes the analysis models and their associated datasets available to teams of accredited users. This encourages reusing and adapting data for maximum productivity and makes it possible to accelerate production while minimizing costs and risks.

According to one variant, the Forge function (2) is a storage zone, a warehouse for the analytical components, the models and the datasets.

In another variant, this Forge function also serves as catalog, providing access to components constituting Development Tools (Jupyter*, R*, Python*, etc.) or as catalog also providing access to template blueprints.

In one variant, the Forge function (2) also comprises pre-trained models stored in memory in the system and accessible to the user by a selection interface, in order to enable transfer learning, use cases for rapid end-to-end development, technological components as well as to set up specific user environments and use cases.

In an additional variant, the Forge function (2) comprises a program module which, when executed on a server or a machine, makes it possible to create a private workspace shared across a company or a group of accredited users in order to store, share, recover and update, in a secure manner (for example after authentication of the users and verification of the access rights (credentials)), component plans, deep learning frameworks, datasets and trained models and forming a warehouse for the analytical components, the models and the datasets.

In another variant, the Forge function enables all the members of a project team to collaborate on the development of an application. This improves the quality and speed of development of new applications in line with business expectations.

A variant of the Forge function (2) further comprises a program module and an MMI interface making it possible to manage a catalog of datasets, as well as a catalog of models and a catalog of frameworks (Fmks) available for the service, thus providing an additional facility to users, preferably to the Data Scientist.

In another variant, the Forge function makes available a new model derived from a previously qualified model.

In another variant, the Forge function makes available to accredited users a catalog providing access to components:

Of Machine Learning type, such as ML frameworks (e.g. Tensorflow*), but also models and datasets; or of Big Data Analytics type (e.g. the Elastic* suite, Hadoop* distributions, etc.) for the datasets.

Finally, in one variant, the Forge function (2) comprises an algorithm which makes it possible to industrialize AI instances and make analytical models and their associated datasets available to the accredited teams and users.

The use of the Orchestration function (3), which manages the total implementation of the AI instances designed using the STUDIO function and industrialized by the Forge function performs permanent management on a hybrid cloud infrastructure transforms the AI application domain effectively.

According to one variant, the operating principle of the orchestration function performed by a Yorc program module receiving a TOSCA* application (also referred to as topology) is:
the allocation of physical resources of the Cloud or an HPC corresponding to the Compute component (depending on the configurations, this may be a virtual machine, a physical node, etc.),
with the installation, on this resource, of software specified in the TOSCA application for this Compute, in this case a Docker container, and in our case mounting the specified volumes for this Compute.

In one variant, the deployment of such an application (in the TOSCA standard) by the Yorc orchestrator is carried out using the Slurm plugin of the orchestrator which triggers the planning of a slurm task (scheduling of a slurm job) on a high performance computing (HPC) cluster.

According to one variant, the Yorc orchestrator monitors the available resources of the supercomputer or of the cloud and, when the required resources are available, a node of the supercomputer or of the cloud is allocated (corresponding to the TOSCA Compute), the container (DockerContainer) is installed in this supercomputer or on this node and the volumes corresponding to the input and output data (DockerVolume) are mounted, then the container is executed.

In another variant, the Orchestration function (orchestrator) proposes to the user connectors to manage the applications on different infrastructures, either in Infrastructure as a Service (IaaS) (such as, for example, AWS*, GCP*, Openstack*, etc.) or in Content as a Service (CaaS) (such as, for example, Kubernetes for now*), or in High-Performance Computing HPC (such as, for example, Slurm*, PBS* planned).

In some embodiments, the system described previously further comprises a fast machine learning engine FMLE (FastML Engine) in order to facilitate the use of computing power and the possibilities of high-performance computing clusters as execution support for a machine learning training model and specifically a deep learning training model.

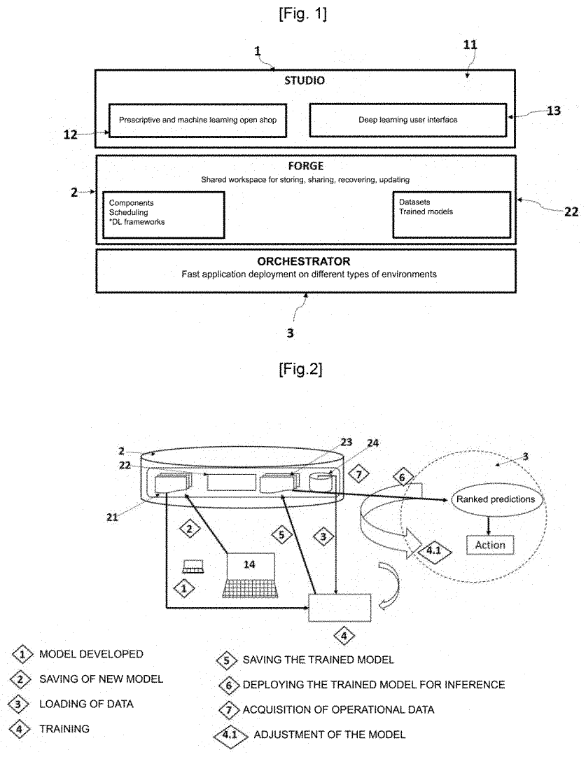

FIG. 2 schematically shows an example of use of the system by a data scientist. In this example, the user accesses their secure private space by exchanging, via the interface 14 of Studio, their accreditation information, then selects at least one model (21), at least one framework (22), at least one dataset (24) and optionally a trained model (23).

According to a use variant for forming use cases, making it possible in particular to enhance the collection of “blueprints” and Forge components (catalog) in the fields of cybersecurity, where upstream detection of all the phases preceding a targeted attack is a crucial problem The availability, large amounts of data (Big data), make it possible currently to contemplate a preventative approach for attack detection. The use of AI for Prescriptive SOCs (Security Operations Center) provides solutions. With the collection and processing of data originating from different sources (external and internal), a base is fed. Machine Learning and data visualization processes then make it possible to carry out behavioral analysis and predictive inference in SOCs. This possibility of being able to anticipate attacks which is offered by the suite of tools of FIG. 1 is much better suited to current cybersecurity with the use of AI for Prescriptive SOCs.

According to another use variant for forming use cases, making it possible in particular to enhance the collection of “blueprints” and Forge components (catalog) in the field of CDC, which is an intelligent and autonomous data center capable of receiving and analyzing data from the network, servers, applications, cooling systems and energy consumption, the use of the system of FIG. 1 enables real-time analysis of all events, provides interpretation graphs with predictions using a confidence indicator regarding possible failures and elements that will potentially be impacted. This thus makes it possible to optimize the availability and performance of the applications and infrastructures.

According to another use variant for forming use cases, making it possible in particular to enhance the collection of “blueprints” and Forge components (catalog) in the fields of computer vision and video surveillance, the system of FIG. 1 makes available the latest image analysis technologies and provides a video intelligence application capable of extracting features from faces, vehicles, bags and other objects and provides powerful services for facial recognition, crowd movement tracking, people search based on given features, license plate recognition, inter alia.

Finally, the deployment of the model on a server or a machine is carried out by the orchestrator (3) which also manages the training.

In a final step, the trained model is saved in Forge (2) and enhances the catalog of trained models (23).

The present application describes various technical features and advantages with reference to the figures and/or various embodiments. A person skilled in the art will understand that the technical features of a given embodiment may in fact be combined with features of another embodiment unless the opposite is explicitly mentioned or it is not obvious that these features are incompatible or that the combination does not provide a solution to at least one of the technical problems mentioned in the present application. In addition, the technical features described in a given embodiment may be isolated from the other features of this mode unless the opposite is explicitly stated.

It should be obvious for a person skilled in the art that the present invention allows embodiments in many other specific forms without departing from the scope of the invention as claimed. Therefore, the present embodiments should be considered to be provided for purposes of illustration, but may be modified within the range defined by the scope of the attached claims, and the invention should not be limited to the details provided above.

1. A system using a suite of modular and clearly structured Artificial Intelligence application design tools (SOACAIA), executable on computing platforms to browse, develop, make available and manage AI applications, this set of tools implementing three functions:
a Studio function (1) making it possible to establish a secure and private shared space for the company wherein the extended team of business analysts, data scientists, application architects and IT managers can communicate and work together collaboratively;
a Forge function (2) making it possible to industrialize AI instances and make analytical models and their associated datasets available to the development teams, subject to compliance with security and processing conformity conditions; and
an Orchestration function (3) for managing the total implementation of the AI instances designed by the STUDIO function and industrialized by the Forge function and to carry out permanent management on a hybrid cloud or HPC infrastructure.

2. A system using a suite (SOACAIA) of modular and clearly structured tools, executable on computing platforms wherein the AI applications are made independent of the support infrastructures by TOSCA—supported orchestration which makes it possible to build applications that are natively transportable through the infrastructures.

3. The system using a suite (SOACAIA) of modular and clearly structured executable tools according to claim 1, wherein the Studio function comprises an open shop for developing cognitive applications comprising a prescriptive and machine learning open shop and a deep learning user interface.

4. The system using a suite (SOACAIA) of modular and clearly structured executable tools according to claim 3, wherein the Studio function provides two functions:
a first, portal function, providing access to the catalog of components, enabling the assembly of components into applications (in the TOSCA standard) and making it possible to manage the deployment thereof on various infrastructures; and
a second, MMI and FastML engine user interface function, providing a graphical interface providing access to the functions for developing ML/DL models of the FastML engine.

5. The system using a suite (SOACAIA) of modular and clearly structured executable tools according to claim 3, wherein the portal of the Studio function (in the TOSCA standard) provides a toolbox for managing, designing, executing and generating applications and test data and comprises:
an interface allowing the user to define each application in the TOSCA standard based on the components of the catalog which are brought together by a drag-and-drop action in a container (DockerContainer) and for their identification the user associates to them, via this interface, values and actions, in particular volumes corresponding to the input and output data (DockerVolume); and
a management menu makes it possible to manage the deployment of at least one application (in the TOSCA standard) on various infrastructures by offering the different infrastructures (Cloud, Hybrid Cloud, cloud hybrid, HPC, etc.) proposed by the system in the form of a graphical object and by bringing together the infrastructure on which the application will be executed by a drag-and-drop action in a “compute” object defining the type of computer.

6. The system using a suite (SOACAIA) of modular and clearly structured executable tools according to claim 1, wherein the Forge function comprises pre-trained models stored in memory in the system and accessible to the user by a selection interface, in order to enable transfer learning, use cases for rapid end-to-end development, technological components as well as to set up specific user environments and use cases.

7. The system using a suite (SOACAIA) of modular and clearly structured executable tools according to claim 1, wherein the Forge function comprises a program module which, when executed on a server, makes it possible to create a private workspace shared across a company or a group of accredited users in order to store, share, find and update, in a secure manner (for example after authentication of the users and verification of the access rights (credentials)), component plans, deep learning frameworks, datasets and trained models and forming a warehouse for the analytical components, the models and the datasets.

8. The system using a suite (SOACAIA) of modular and clearly structured executable tools according to claim 1, wherein the Forge function comprises a program module and an MMI interface making it possible to manage a catalog of datasets, and also a catalog of models and a catalog of frameworks (Finks) available for the service, thus providing an additional facility to the Data Scientist.

9. The system using a suite (SOACAIA) of modular and clearly structured executable tools according to claim 1, wherein the Forge function proposes a catalog providing access to components:
a of Machine Learning type, such as ML frameworks (e.g. Tensorflow*), but also models and datasets of Big Data Analytics type (e.g. the Elastic* suite, Hadoop* distributions, etc.) for the datasets.

10. The system using a suite (SOACAIA) of modular and clearly structured executable tools according to claim 1, wherein the Forge function is a catalog providing access to components constituting development Tools (Jupyter*, R*, Python*, etc.).

11. The system using a suite (SOACAIA) of modular and clearly structured executable tools according to claim 1, wherein the Forge function is a catalog providing access to template blueprints.

12. The system using a suite (SOACAIA) of modular and clearly structured executable tools according to claim 1, wherein the operating principle of the orchestration function performed by a Yorc program module receiving a TOSCA* application as described above (also referred to as topology) is that of allocating physical resources corresponding to the Compute component (depending on the configurations this may be a virtual machine, a physical node, etc.), then it will install, on this resource, software specified in the TOSCA application for this Compute, in this case a Docker container, and in our case mount the specified volumes for this Compute.

13. The system using a suite (SOACAIA) of modular and clearly structured executable tools according to claim 1, wherein the deployment of such an application (in the TOSCA standard) by the Yorc orchestrator is carried out using the Slurm plugin of the orchestrator which will trigger the planning of a slurm task (scheduling of a slurm job) on a high performance computing (HPC) cluster.

14. The system using a suite (SOACAIA) of modular and clearly structured executable tools according to claim 1, wherein the Yorc orchestrator monitors the available resources of the supercomputer or of the cloud and, when the required resources are available, a node of the supercomputer or of the cloud will be allocated (corresponding to the TOSCA Compute), the container (DockerContainer) will be installed in this supercomputer or on this node and the volumes corresponding to the input and output data (DockerVolume) will be mounted, then the container will be executed.

15. The system using a suite (SOACAIA) of modular and clearly structured executable tools according to claim 1, wherein the Orchestration function (orchestrator) proposes to the user connectors to manage the applications on different infrastructures, either in Infrastructure as a Service (IaaS) (such as, for example, AWS*, GCP*, Openstack*, etc.) or in Content as a Service (CaaS) (such as, for example, Kubernetes for now*), or in High-Performance Computing HPC (such as, for example, Slurm*, PBS* planned).

16. The system using a suite (SOACAIA) of modular and clearly structured executable tools according to claim 1, wherein it further comprises a fast machine learning engine FMLE (FastML Engine) in order to facilitate the use of computing power and the possibilities of high-performance computing clusters as execution support for a machine learning training model and specifically a deep learning training model.

17. A use of the system using a suite (SOACAIA) of modular and clearly structured executable tools according to claim 1, wherein for forming use cases, which will make it possible in particular to enhance the collection of “blueprints” and Forge components (catalog): the first use cases identified being:
cybersecurity, with use of the AI for Prescriptive SOCs;
Cognitive Data Center (CDC) computer vision, with video surveillance applications.
